(19) United States
(12) Patent Application Publication
(10) Pub. No.: US 2024/0277557 A1
(43) Pub. Date: Aug. 22, 2024

(54) MASSAGE SYSTEM

(71) Applicant: AUDI AG, Ingolstadt (DE)

(72) Inventors: Susanne MENTZEL, Ingolstadt (DE); Frank LEWANDOWSKI, Altmannstein (DE); Nikolas KLOSE, Eitensheim (DE); Tobias LANDGRAF, Manching (DE); Josef MEIER, Kösching (DE); Frank THIERFELD, Kaiserslautern (DE); Martin REUTER, Dresden (DE)

(73) Assignee: AUDI AG, Ingolstadt (DE)

(21) Appl. No.: 18/571,291

(22) PCT Filed: Jul. 6, 2022
(86) PCT No.: PCT/EP2022/068699

§ 371 Date: Dec. 18, 2023

(30) Foreign Application Priority Data
Aug. 9, 2021 (DE) 102021120600.6

(51) Int. Cl. A61H 9/00; B60N 2/90

(52) U.S. Cl. CPC A61H 9/0007; A61H 9/0078; B60N 2/976; A61H 2201/0103; A61H 2201/0149; A61H 2201/1238; A61H 2201/1678; A61H 2205/086; A61H 2205/088

(57) ABSTRACT

A massage system for a seat of a vehicle, which has a seat surface. Multiple massage bubbles are arranged in the seat surface of the seat, and each massage bubble is designed to carry out at least one lifting movement having a component extending perpendicular to the seat surface, to touch a body of a person seat-ed on the seat surface in an area, and to carry out a massage for this area. At least two massage bubbles are designed to carry out their respective lifting movements in a time-coordinated manner and in accordance with at least one intended movement pattern.

### FIELD

The invention relates to a massage system for a seat and a method for carrying out a massage.

### BACKGROUND

A massage arrangement can be integrated into a seat of a vehicle, using which a person sitting on the seat can be massaged.

Document JP 2015/102891 A describes an arrangement which has multiple vibrators which are integrated in a vehicle seat and are designed to warn a person sitting on the vehicle seat of a driving situation of the vehicle by vibration.

A device for a seat of a vehicle for performing a lumbar massage is known from document GB 2565226 A.

Document JP 2008/077631 A also describes that vibration elements are arranged in a vehicle seat.

### SUMMARY

Against this background, it was an object to improve a massage for an occupant of a vehicle. The massage system according to the invention is designed for a seat or vehicle seat of a vehicle, for example a motor vehicle. The seat has a seat surface, wherein a number of massage bubbles of the massage system are arranged in the seat surface of the seat. Each massage bubble is designed to carry out at least one lifting movement, for example multiple lifting movements in succession. This at least one lifting movement has a component that extends perpendicular to the seat surface and/or is oriented, usually vectorial, wherein the at least one lifting movement is at least partially perpendicular, in one embodiment completely perpendicular, to the seat surface and/or is oriented vertically upwards relative to a vehicle longitudinal direction. The at least one massage bubble is designed to touch a body of a person sitting on the seat of the seat in an area while carrying out the at least one lifting movement and to carry out a massage for this area. At least two massage bubbles among the number of massage bubbles are designed to carry out their respective lifting movements in a time-coordinated manner with one another and in accordance with at least one intended movement pattern, for example an order and/or sequence for lifting movements of the massage bubbles. In this case, a joint coordinated and/or concerted movement is carried out by the massage bubbles while carrying out all lifting movements in accordance with the at least one intended movement pattern. Depending on the movement pattern, it is possible here for lifting movements of multiple massage bubbles to be carried out in temporal succession. Alternatively or additionally, depending on the movement pattern, it is possible for at least two lifting bubbles to carry out lifting movements at the same time.

In consideration of the respective order and/or sequence for the lifting movements, the massage bubbles in the seat are activated temporally in succession or simultaneously, wherein a respective massage bubble carries out its respective intended lifting movement due to such activation. To provide the at least one intended movement pattern, a spatial distribution of the massage bubbles in the seat is also taken into consideration, wherein the lifting movements of all activated massage bubbles in the seat are carried out in a spatially and temporally distributed manner, wherein for a respective variant of a massage, the at least one movement pattern of lifting movements provided for this is implemented. A respective lifting movement is generally oriented perpendicular to the seat surface and/or vertically relative to the vehicle longitudinal direction. In an embodiment, it is also possible for at least one lifting movement, which is carried out and/or can be carried out by at least one massage bubble, to be vectorially oriented in a first larger proportion perpendicular to the seat surface and/or vertically relative to the vehicle longitudinal direction and in a second smaller proportion is or will be oriented parallel to the seat surface and/or horizontally. The at least one lifting movement comprises the first vectorial component perpendicular to the seat surface and possibly also a second vectorial component parallel to the seat surface. It is possible for a vectorial direction or orientation of the lifting movement to be related to a contour and/or shape of a surface of the seat surface, wherein the contour of the surface of the seat surface is flat at least in some sections and/or curved at least in some sections. An orientation of a lifting movement of a respective massage bubble can be arbitrary and/or adjusted as required by way of the seat as a support surface. Depending on the design and/or geometry of a respective massage bubble, it is possible that it carries out a vertical lifting movement or an oblique lifting movement relative to the seat surface, which is oriented at an acute angle relative to the seat surface. The direction of the lifting movement of at least one massage bubble can be varied, usually depending on the angle and/or dynamically.

The massage bubbles are arranged symmetrically relative to a central axis or axis of symmetry of the seat surface, which is oriented parallel to a forward direction of travel or to the vehicle vehicle longitudinal direction, wherein a first group of massage bubbles and a second group of massage bubbles are distributed and/or arranged spatially symmetrically in relation to one another with respect to the central axis in the seat surface.

As a rule, at least one massage bubble is designed as a pneumatic massage bubble.

The massage system has at least one control device which is connected to the at least one massage bubble and is designed to supervise, i.e., control and/or regulate, a lifting movement of the at least one massage bubble. The control device is usually connected to all massage bubbles and is designed to control or actuate each massage bubble individually and thereby activate it and cause it to carry out the at least one lifting movement. Furthermore, the control device is designed to temporally supervise, i.e., control and/or regulate, the lifting movements of the at least two massage bubbles in accordance with the at least one intended movement pattern, and to generate a temporal and spatial sequence of the lifting movements.

Each control device is connected to only one massage bubble or to multiple massage bubbles. Furthermore, at least one valve is assigned to the at least one control device and/or the at least one massage bubble, which is actuated by the at least one control device and is designed to change an amount of air in the at least one massage bubble. In one embodiment, multiple massage bubbles, for example two massage bubbles, are connected to a common valve via at least one hose or tubing for conveying air, wherein the same amount of air is filled into these massage bubbles via the common valve, wherein the valve and thus also the massage bubbles are also controlled by a common control device. It is conceivable that three hoses are connected to one another and form a Y-shaped arrangement, wherein one hose is connected to the valve and each one of the other two hoses is connected to one of the two massage bubbles.

The method according to the invention is intended for massaging at least one area of a body of a person sitting on a seat surface of a seat of a vehicle, wherein a massage system, for example an embodiment of the massage system presented here, is used for the seat of the vehicle. A number of multiple massage bubbles of the massage system are arranged in the seat surface of the seat, wherein each massage bubble carries out at least one lifting movement having a, usually vectorial, component extending perpendicular to the seat surface, wherein this at least one lifting movement is oriented at least partially, possibly completely, perpendicular to the seat surface or, depending on the definition, vertically upwards relative to the vehicle longitudinal direction. The body of the person sitting on the seat is dynamically touched in the at least one area by the respective massage bubble when the at least one lifting movement is carried out and the massage is carried out for this at least one area. At least two massage bubbles among the number of massage bubbles are designed to carry out their respective lifting movements in a time-coordinated manner with one another and in accordance with at least one intended movement pattern, for example in accordance with an order and/or sequence for lifting movements of the massage bubbles. It is possible that different movement patterns of lifting movements are temporally and/or spatially superimposed.

In the method, at least one thigh, i.e., an underside of the thigh that touches the seat, an ischial tuberosity, and/or a buttock or gluteal muscle of the person on the seat is massaged as the at least one area. It is possible that an area on the ischial tuberosity and/or next to the ischial tuberosity, usually the gluteal muscle, is massaged.

To provide the at least one intended movement pattern of lifting movements, at least one first lifting movement is carried out by at least one first massage bubble and a second lifting movement is carried out immediately by at least one second massage bubble. It is possible for the lifting movements to be carried out immediately in succession, wherein a continuous movement pattern of lifting movements is provided and/or generated. Alternatively or additionally, a pause can be provided between each two lifting movements carried out in succession.

Furthermore, it is possible for the at least one first massage bubble to be arranged in front of or behind the at least one second massage bubble with respect to a forward direction of travel of the vehicle. Alternatively or additionally, it is taken into consideration that the at least one first massage bubble and the at least one second massage bubble are or will be separated from one another by the central axis with respect to a central axis of the seat surface, which is oriented parallel to a forward direction of travel of the vehicle, or are arranged on the same side of the seat surface with respect to the central axis.

In the method, different movement patterns can be set for lifting movements of the massage bubbles that are to be carried out or can be carried out in a temporally coordinated manner, wherein a joint temporally and spatially coordinated movement for the massage is generated from the individual lifting movements using the massage system. It is possible for the lifting movements to be carried out relative to the forward direction of travel of the vehicle either from front to back or from back to front, wherein it is possible for two different sequences of lifting movements to be carried out synchronously and/or symmetrically with respect to the forward direction of travel, wherein the massage bubbles are activated synchronously and symmetrically on one side of the central axis and on the other side of the central axis, i.e., on one hand on the left and on the other hand on the right of the central axis. Alternatively or additionally, it is also possible for at least one sequence of lifting movements to be carried out perpendicular to the central axis and thus also perpendicular and/or horizontal to the forward direction of travel of the vehicle, wherein the lifting movements are oriented largely perpendicular to the seat surface. It is also possible for at least two massage bubbles to be activated at the same time and thus each carry out a lifting movement at the same time. In addition, to generate the intended movement pattern, it is possible for at least one massage bubble to be activated multiple times in succession and accordingly to carry out multiple lifting movements in succession.

In one embodiment, a first sequence of lifting movements is carried out by a first set of massage bubbles in succession and a second sequence of lifting movements is carried out by a second set of massage bubbles in succession, wherein the massage bubbles of the first set and the massage bubbles of the second set are arranged symmetrically with respect to the central axis of the seat surface and/or wherein the two sequences of lifting movements are carried out synchronously with one another. When carrying out different sequences of lifting movements of different amounts of massage bubbles, it is possible that first a first area of the body, for example a first thigh, either the left or right thigh, is massaged by the first set of massage bubbles, and then a second area of the body, for example a second thigh, either the right or left thigh, is massaged by the second set of massage bubbles.

Furthermore, the massage bubbles, which are designed as pneumatic massage bubbles, are filled with a fluid, usually a gas, for example air, wherein the same amount of gas is stored in at least two pneumatic massage bubbles at one time, and/or wherein different amounts of air are stored in at least two pneumatic massage bubbles. It is possible for multiple massage bubbles, for example two massage bubbles, to be filled with air at one time or at the same time, wherein lifting movements are carried out by at least two massage bubbles at the same time. It is also possible for only one massage bubble to be filled with air at a time, wherein a lifting movement is only carried out by one massage bubble at a time. Independently of how many massage bubbles are or will be filled with air at a time or at the same time, one massage bubble at a time is filled with air at the beginning of its lifting movement, the air is held in the massage bubble, and it is vented again to complete this lifting movement. When carrying out a movement pattern, multiple massage bubbles can, for example, carry out a circular movement together, wherein multiple massage bubbles, which are arranged in a circle with respect to one another, carry out their lifting movements in succession. In one embodiment, an angle-dependent direction of a lifting movement relative to the seat surface can be varied, changed, and/or adjusted by, usually dynamically, controlling the amount of air in at least one massage bubble.

By changing the amount of gas in a respective massage bubble, i.e., either by supplying gas or by removing gas, the respective massage bubble carries out one or its intended lifting movement. It is possible here for the massage system to have at least one compressor for gas, which interacts with the control device presented, wherein the at least one compressor is actuated by the control device and changes the amount of gas in the respective massage bubble based on a respective actuation by the control device.

The method and the massage system can therefore be used to carry out a thigh massage for the person sitting on the seat. It is possible here for multiple massage bubbles to be provided for each thigh, which are introduced into the seat surface and/or arranged therein, and it is also possible for multiple massage bubbles to be provided for each thigh in the seat surface under an intended position of the thigh, and are arranged to the left and/or right of the intended position of the thigh on the seat. Furthermore, it is possible to massage an ischial tuberosity, a buttock, or a gluteal muscle of the person by way of at least one massage bubble. By carrying out a respective movement pattern, multiple massage bubbles carry out spatially and temporally distributed movements which are and/or will be oriented in different directions, for example also symmetrically. By providing a respective movement pattern, it is also possible for multiple massage bubbles, which are activated in succession in space and time and carry out corresponding lifting movements, to be able to carry out a rotating movement overall. Due to an intended movement pattern and the resulting flat movement of the massage bubbles, it is possible to massage the area of the person pleasantly. In this embodiment, it is possible, among other things, for a respective movement pattern or a corresponding movement, for example, to approximately follow a lymph flow in the area of the person.

In an embodiment of the massage system, it is possible that multiple massage bubbles, for example four massage bubbles, are arranged one behind the other in a usually straight row or along an at least partially curved line and are furthermore activated in temporal succession along a corresponding straight line or line and carry out the lifting movements in succession to provide the intended movement pattern. In one embodiment, it is possible for two rows of massage bubbles to be arranged to the left and right of a respective thigh or a position and/or orientation of the thigh relative to the central axis, wherein an elongated recess is or will be formed in the seat between the two rows, which is free of massage bubbles, wherein a respective thigh is arranged on this recess without massage bubbles. Such rows of massage bubbles are usually oriented at an acute angle, possibly parallel, to the central axis of the seat. It is also possible for a further row of massage bubbles to be arranged in the seat surface at the front, i.e., at the front with respect to the forward direction of travel of the vehicle, which is oriented perpendicular to the central axis and can have, for example, four massage bubbles. By combining all massage bubbles, it is possible to create a rotating movement from individual lifting movements. A number of rows of massage bubbles, a respective orientation of a row, and a number of massage bubbles can be selected in each case. A respective row for massaging the thigh has, for example, four to six massage bubbles. A respective row for massaging the thigh has, for example, two to four massage bubbles and therefore fewer massage bubbles than for the entire thigh.

The virtual central axis intersects the seat surface and virtually divides the seat surface into two sides, which are separated from one another by the central axis. Each massage bubble has at least one active surface which is arranged on at least one of the two sides, i.e., only on one side and/or on the first side and on the second side, of the seat surface. The at least one active surface of the at least one massage bubble is designed to carry out at least one lifting movement having a vectorial component oriented perpendicular to the seat surface or its surface. The lifting movement is therefore at least partially oriented or aligned perpendicular to the seat surface and possibly also partially parallel to the seat surface, by which the massage bubble is designed to touch the body of a person sitting on the seat in the area and to carry out the massage for this area of the person. If the person is sitting on the seat, the at least one lifting movement is oriented and/or directed substantially towards the area of the body of the person.

In an embodiment of the massage system, at least two rows of massage bubbles are arranged in the seat surface, wherein these rows are arranged symmetrically to one another on the first side and on the second side of the seat surface next to the central axis.

Massage bubbles, which are arranged within two rows arranged directly adjacent one another, can together form and/or delimit a concave curvature on the seat surface, wherein the recess without massage bubbles is located between the two rows.

In one embodiment, the massage system has at least one pneumatic and/or electrical control device, for example a control device and/or regulating device, in particular a pneumatic and/or electromechanical control device, for example a pump, each of which is pneumatically and/or electrically connected to at least one massage bubble and is designed to control the timing of the lifting movement of the massage bubbles in the direction of the area of the person to be massaged. The amount of air in the massage bubbles is usually dynamically changed. A control device designed, for example, as a pneumatic control device, for example a control device controls a compressor and valves that are assigned to the massage bubbles. The volume flow and pressure generated by the compressor are passed on to the valves via air ducts. The air flow from the valves is directed into the massage bubbles via air ducts. For deaeration, the air flow from the massage bubbles is directed through the valves into the environment. The valves are either open to the environment, wherein a volume and pressure of the air in the massage bubbles are reduced, or closed, wherein the volume and pressure remain constant. When the massage bubbles are aerated and deaerated, an adjustment path and a force result in accordance with the lifting movement. The adjustment path and the force are transferred to the foam, backlining, and cover of the seat surface.

In a further embodiment, for example, air is filled, for example pumped, into the pneumatic massage bubbles by the pneumatic control device and, in a possible embodiment, is also extracted from the pneumatic massage bubbles again. When filling the massage bubble, the pressure of the air inside can be increased and reduced when extracting. The same amount of air can be stored in at least two pneumatic massage bubbles and/or different amounts of air can be stored in at least two pneumatic massage bubbles at one time.

Typically, at least one pneumatic massage bubble is oriented at least perpendicularly or vertically relative to the seat surface and, if necessary, is at least partially also oriented or inclined parallel to the seat surface or horizontally. Using the massage system, the seat surface is, among other things, functionally expanded in relation to a known seat surface. It is possible to carry out a direct massage. By actuating and/or activating at least one massage bubble at a time, which is assigned to a respective body part or area of the body of the person, this body part can be massaged using an embodiment of the massage system during the method.

At least one massage bubble can be designed as a multiple-stroke bubble, for example as a double-stroke, triple-stroke, quadruple-stroke, five-fold-stroke, or six-fold-stroke massage bubble, wherein a multiple-stroke bubble has multiple pneumatic chambers which are arranged one above the other or one below the other relative to the intended lifting movement. Chambers of a massage bubble, which is designed as a multiple-stroke bubble, can be welded to an inside of the at least one massage bubble via at least one band, for example a foil band and/or tension band. Furthermore, multiple massage bubbles can optionally be directly connected to one another via welded seams. It is possible for two massage bubbles and/or chambers of a massage bubble to be connected to one another via at least one hose.

In an embodiment of the method, the at least one massage bubble can be used to exert soft, minor pressure on a respective area of the body of the person. Furthermore, during the massage, a movement that encloses the area, for example the thigh and/or the ischial tuberosity, can be carried out. This can mean that multiple massage bubbles are focused or aligned on a point on the body of the person from different directions, enclose it and, in accordance with the intended movement pattern of lifting movements, carry out an enclosing movement that encloses the point or area.

When the massage system is operated as part of the method, in addition to, for example, longitudinal lifting movements perpendicular to the seat surface, the massage bubbles carry out different movements, for example rotations. Different variants are possible for rotations, for example for rotations of chambers of a massage bubble. The lifting movement can be overlaid by a rotational movement outwards, inwards, up, down, forward, and/or back.

A stroke or bubble stroke or a length by which the massage bubble is moved relative to the seat surface when the lifting movement is carried out has an adjustable maximum value as required, wherein an intensity of the massage can be adjusted. Different, in particular flexible and/or elastically deformable materials can be provided for the massage bubbles, usually for covers of chambers of the massage bubbles. A respective cover encloses an interior of a respective chamber of a massage bubble. When the massage system is in operation, an amount of air within the interior of the chamber of the respective massage bubble, which is enclosed by the, for example, elastic cover, is changed, that is, increased and reduced, for example, rhythmically, periodically, oscillating, and/or cyclically, wherein a volume of the at least one massage bubble is changed rhythmically, periodically, oscillating, and/or cyclically. The at least one massage bubble and/or chamber or its cover can be made of very stretchable material, for example an elastomer, similar to a balloon. The at least one massage bubble and/or chamber can, for example, also be designed as a bellows, which is formed, for example, from a thermoplastic material, for example from polypropylene (PP) or ethylene-propylene-diene rubber (EPDM), wherein its length or its stroke is lengthened like an accordion when the pressure of the air therein is higher and shortened when the pressure is lower. The massage bubbles can be produced, for example, from punched film material. Multiple sections of this film material can be connected, for example welded, to form a massage bubble.

In one embodiment of the method or during operation of the massage system and thus during a process of the massage, the chambers of the massage bubbles are filled with air individually and/or depending on the time according to the movement pattern, wherein different amounts of air are located in chambers of different massage bubbles at one time, wherein the massage bubbles will be or are raised and/or expanded to different degrees. In this case, it is conceivable, for example, that first at least one massage bubble on a left side of the seat surface and then at least one massage bubble on the right side of the seat surface is filled with air, or vice versa. Alternatively or additionally, at least one rear massage bubble can first be filled with air, which is arranged in the seat behind at least one front massage bubble according to the forward direction of travel, wherein the at least one front massage bubble is only filled with air and activated after the at least one rear massage bubble, or vice versa. It is also possible for multiple massage bubbles to be alternately filled with air and activated in an oscillating manner along the forward direction of travel and/or perpendicular thereto, wherein it is possible for a movement pattern to be generated from, for example, superimposed lifting movements, which move back and forth alternately parallel and/or perpendicular to the forward direction of travel. Temporally superimposed lifting movements or a pause, usually between two lifting movements, are also possible.

By, for example, dynamically changing an amount of air in the chambers of the massage bubbles, a contour of the seat surface that touches the body of the person is changed at least in some areas, wherein the contour of the seat can be changed depending on how much air is currently in a respective massage bubble, for example, in a wave-like, cyclical, rhythmic, and/or oscillating manner. It is also possible to fill multiple, for example all, massage bubbles at the same time with air or to extract it therefrom.

The massage bubbles can be varied in terms of their shape and accordingly designed differently. At least one massage bubble, usually its active surface, can be made round, oval, polygonal, for example rectangular or square. Accordingly, different massage bubbles or their active surfaces, which are integrated into the seat surface, can have different shapes and be of different sizes, wherein at least some massage bubbles are smaller and others are larger. Multiple massage bubbles and/or chambers of each massage bubble can be fastened to one another on a weld seam, for example a cambered weld seam or corrugated weld seam.

Multiple massage bubbles can be arranged differently, for example along the row or a line, adjacent to one another and/or one behind another, in particular directly adjoining or bordering one another, or in a circle or radially. Two directly adjacent massage bubbles can be spaced apart from one another, wherein a distance or a gap and thus a recess is located between these massage bubbles. In an embodiment of the method, massage bubbles are filled with air individually or in pairs. A sequence for lifting movements, according to which the massage bubbles are filled with air, can vary in a respective embodiment of the method, taking into consideration the movement pattern intended in each case.

The massage bubbles can be fastened differently in and/or on the seat surface. The at least one massage bubble can be plugged, stapled, and/or welded onto a foil strip, in particular by plugging foil strips. For its fastening, the at least one massage bubble can be glued to and/or on the seat surface, welded thereon and/or clipped thereto and/or plugged thereon.

The at least one massage bubble is designed to be pneumatic and, in an optional further embodiment, can also have at least one mechanical element, in particular a lifting element, for example a motor and/or a transmission, at least one pneumatic cylinder, at least one vibration motor, at least one motor with unbalance, and/or at least one loudspeaker, for example for exciting the air in the at least one massage bubble, and/or can cooperate or be connected to such a mechanical element, wherein in an embodiment of the method a vibration massage is additionally carried out using the vibration motor and/or the loudspeaker, which can be overlaid with at least one lifting movement. In addition, the at least one massage bubble can have at least one finger, i.e., a pin having a rounded end, as a mechanical element.

### BRIEF DESCRIPTION OF THE FIGURES

The invention is illustrated schematically in the set of drawings on the basis of embodiments, and will be described schematically and in detail with reference to the drawings.

FIG. 1 shows a schematic representation of an embodiment of the massage system according to the invention for a seat of a vehicle.

FIG. 2 shows a schematic representation of a variant of an embodiment of the method according to the invention, which is carried out using the embodiment of the massage system according to the invention from FIG. 1.

FIG. 3 shows a schematic representation of a variant of an embodiment of the method according to the invention, which is carried out using the embodiment of the massage system according to the invention from FIG. 1.

FIG. 4 shows a schematic representation of a variant of an embodiment of the method according to the invention, which is carried out using the embodiment of the massage system according to the invention from FIG. 1.

FIG. 5 shows a schematic representation of a variant of an embodiment of the method according to the invention, which is carried out using the embodiment of the massage system according to the invention from FIG. 1.

FIG. 6 shows a schematic representation of a variant of an embodiment of the method according to the invention, which is carried out using the embodiment of the massage system according to the invention from FIG. 1.

FIG. 7 shows a schematic representation of a variant of an embodiment of the method according to the invention, which is carried out using the embodiment of the massage system according to the invention from FIG. 1.

FIG. 8 shows a schematic representation of a variant of an embodiment of the method according to the invention, which is carried out using the embodiment of the massage system according to the invention from FIG. 1.

FIG. 9 shows a schematic representation of a variant of an embodiment of the method according to the invention, which is carried out using the embodiment of the massage system according to the invention from FIG. 1.

FIG. 10 shows a schematic representation of a variant of an embodiment of the method according to the invention, which is carried out using the embodiment of the massage system according to the invention from FIG. 1.

FIG. 11 shows a schematic representation of a variant of an embodiment of the method according to the invention, which is carried out using the embodiment of the massage system according to the invention from FIG. 1.

FIG. 12 shows a schematic representation of a variant of an embodiment of the method according to the invention, which is carried out using the embodiment of the massage system according to the invention from FIG. 1.

### DETAILED DESCRIPTION

The figures are described coherently and comprehensively; the same components are assigned the same reference numbers.

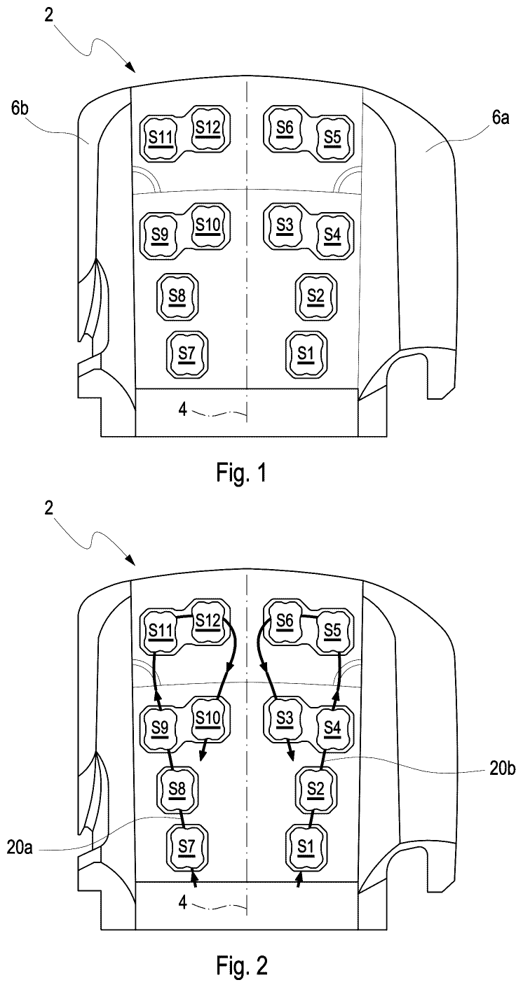

The embodiment of the massage system according to the invention is intended for a seat surface 2 of a seat for a vehicle, for example a motor vehicle, and thus for a vehicle seat. The seat surface 2 has a central axis 4 or axis of symmetry, which is aligned parallel to a usually provided forward direction of travel of the vehicle when the seat having the seat surface 2 is arranged and/or installed in an interior of the vehicle. Furthermore, FIG. 1 shows two side cheeks 6a, 6b, which enclose the seat surface 2 and are here, for example, asymmetrically designed in terms of their shape, wherein a distance between the side cheeks 6a, 6b increases from back to front. Alternatively, it is also possible for these side cheeks 6a, 6b for the seat surface 2 to be designed symmetrically. Independently of a specific design of the side cheeks 6a, 6b, the seat surface 2 is divided into two sides or sections by the central axis 4, wherein a first side is to the right of the central axis 4 and a second side is to the left of the central axis 4.

A total of twelve massage bubbles S1, S2, S3, S4, S5, S6, S7, S8, S9, S10, S11, S12 are arranged here in the seat surface 2, wherein six massage bubbles S1, S2, S3, S4, S5, S6 are arranged on the first side to the right of the central axis 4 and a second number of massage bubbles S7, S8, S9, S10, S11, S12 are arranged here on the second side to the left of the central axis 4.

In the embodiment of the massage system presented here, it is provided in detail that a first massage bubble S1 is arranged on the right on the first side and a seventh massage bubble S7 is arranged on the second side symmetrically to the first massage bubble S1 with respect to the central axis 4. The first and seventh massage bubbles S1, S7 assume a rearmost position with respect to the forward direction of travel of the vehicle. Immediately in front of it, a second massage bubble S2 is arranged symmetrically to the central axis 4 on the right on the first side and an eighth massage bubble S8 on the left on the second side. Furthermore, with respect to the forward direction of travel, a fourth massage bubble S4 is arranged on the right on the first side and, symmetrically thereto, on the left on the second side, a ninth massage bubble S9 is arranged, which are arranged in front of the second and eighth massage bubbles S2, S8 with respect to the forward direction of travel. It is also provided here that the first, second, and fourth massage bubbles S1, S2, S4 are arranged on the first side on the right along a substantially straight row. Symmetrically to this, on the second side on the left, the seventh, eighth, and ninth massage bubbles S7, S8, S9 are also arranged along a substantially straight row, wherein these two rows are arranged symmetrically to the central axis 4. A third massage bubble S3 is arranged here on the right on the first side. A tenth massage bubble S10 is arranged on the left on the second side, which is furthermore arranged symmetrically with respect to the central axis 4 to the third massage bubble S3. Here, the third massage bubble S3 is offset forward with respect to the fourth massage bubble S4, taking into consideration the forward direction of travel. Accordingly, the tenth massage bubble S10 is offset forward relative to the ninth massage bubble S9, taking into consideration the forward direction of travel.

The third and fourth massage bubbles S3, S4 also form a straight row, which is oriented at an obtuse angle to the row made up of the first, second and fourth massage bubbles S1, S2, S4 and forward with respect to the forward direction of travel, wherein this angle opens from back to front. Correspondingly, a row made up of the ninth and tenth massage bubbles S9, S10 is also oriented forward at an obtuse angle and with respect to the forward direction of travel relative to the row made up of the seventh, eighth, and ninth massage bubbles S7, S8, S9. With respect to the forward direction of travel, a fifth massage bubble S5 and a sixth massage bubble S6 are arranged farther forward on the right on the first side, wherein the fifth massage bubble S5 is arranged in front of the third massage bubble S3 with respect to the forward direction of travel. The sixth massage bubble S6 is offset forward relative to the fifth massage bubble S5 with respect to the forward direction of travel. An eleventh and a twelfth massage bubble S11, S12 are arranged symmetrically to the fifth and sixth massage bubbles S5, S6 on the left on the second side, wherein the eleventh massage bubble S11 is arranged symmetrically with respect to the central axis 4 to the fifth massage bubble S5 and the twelfth massage bubble S12 is arranged symmetrically with respect to the central axis 4 to the sixth massage bubble S6. It is provided here that the fifth and sixth massage bubbles S5, S6 also form a row, which is here oriented parallel to the row made up of the third and fourth massage bubbles S3, S4. Correspondingly, the eleventh and twelfth massage bubbles S11, S12 are arranged along a row that is oriented parallel to the row made up of the ninth and tenth massage bubbles S9, S10.

In the embodiment of the massage system presented here, it is furthermore provided that the third and sixth massage bubbles S3, S6 and correspondingly also the tenth and twelfth massage bubbles S10, S12 have the smallest distance from the central axis 4. In addition, a distance between the first and seventh massage bubbles S1, S7 is greater than a respective distance between the third, sixth, tenth, or twelfth massage bubbles S3, S6, S10, S12. A respective distance of the second and eighth massage bubbles S2, S8 to the central axis 4 is greater than a respective distance of the first and seventh massage bubbles S1, S7 to the central axis 4. The fourth and fifth massage bubbles S4, S5 and correspondingly the ninth and eleventh massage bubbles S9, S11 each have a maximum distance from the central axis 4, which is greater than a respective distance of the second and eighth massage bubbles S2, S8 from the central axis 4. Distances between two massage bubbles can be varied as needed. Distances between the respective massage bubbles and the central axis can also be varied.

When operating the massage system presented here, a method for massaging at least one area of a body of a person who is sitting on the seat surface 2 of the seat can be carried out and/or is carried out. The thighs and an ischial tuberosity of the person are usually massaged by the massage bubbles S1, S2, S3, S4, S5, S6, S7, S8, S9, S10, S11, S12. It is provided here that each massage bubble S1, S2, S3, S4, S5, S6, S7, S8, S9, S10, S11, S12 is pneumatically actuated by a control device (not shown) of the massage system, wherein an amount of air in a respective massage bubble S1, S2, S3, S4, S5, S6, S7, S8, S9, S10, S11, S12 and thus its volume is usually changed dynamically. When a respective massage bubble S1, S2, S3, S4, S5, S6, S7, S8, S9, S10, S11, S12 is actuated and/or activated, a lifting movement is carried out thereby, which is at least partially, usually largely or completely, is or will be oriented vectorially perpendicular to the seat surface 2 and thus generally vertically to the vehicle longitudinal direction, i.e., these lifting movements have a vectorial component perpendicular to the seat surface 2. It is possible for a direction of the lifting movement to be related to a contour of a surface of the seat surface 2, which, depending on the design of the seat surface, is flat and/or curved in some sections.

In this case, multiple massage bubbles S1, S2, S3, S4, S5, S6, S7, S8, S9, S10, S11, S12 are actuated in a coordinated manner temporally and spatially with respect to a respective position on the seat surface 2, wherein multiple massage bubbles S1, S2, S3, S4, S5, S6, S7, S8, S9, S10, S11, S12 carry out lifting movements in a temporally and/or spatially coordinated manner in accordance with at least one intended movement pattern. It is possible for different movement patterns to be provided for different variants of the embodiment of the method, wherein a respective variant of the embodiment of the method having a respective assigned movement pattern is described below based on the further FIGS. 2 to 12.

To carry out a first variant of the embodiment of the method according to the invention using the massage system, a first movement pattern is shown schematically in FIG. 2 based on a first course 20a made up of arrows and a second course 20b made up of arrows, wherein the two courses 20a and 20b indicate how the massage bubbles S1, S2, S3, S4, S5, S6, S7, S8, S9, S10, S11, S12 are activated in succession in a temporally coordinated manner and carry out the lifting movements intended to provide the movement pattern. Taking into consideration the two courses 20a, 20b made up of arrows, the first massage bubble S1 on the right and the seventh massage bubble S7 on the left are activated at the same time. The second massage bubble S2 on the right and the eighth massage bubble S8 on the left are then likewise activated at the same time. The fourth massage bubble S4 on the right and the ninth massage bubble S9 on the left are then activated at the same time. The fifth massage bubble S5 on the right and the eleventh massage bubble S11 on the left are then activated at the same time. The sixth massage bubble S6 on the right and the twelfth massage bubble S12 on the left are then activated at the same time. Finally, the third massage bubble S3 on the right and the tenth massage bubble S10 on the left are also activated at the same time.

According to the movement pattern presented on the basis of FIG. 2, symmetrical lifting movements are carried out in succession on both sides of the central axis 4 by the massage bubbles S1, S2, S4, S5 on the right and by the massage bubbles S7, S8, S9, S11 on the left, which are oriented forward relative to the forward travel direction, wherein a position of a respective lifting movement relative to the central axis 4 initially increases. Thereafter, lifting movements are carried out by the massage bubbles S5 and S6 on the right and symmetrically thereto by the massage bubbles S11 and S12, which are oriented forward with respect to the forward direction of travel and furthermore in the direction of the central axis 4. Finally, the lifting movements continue from the massage bubble S6 to the massage bubble S3 and symmetrically thereto from the massage bubble S12 to the massage bubble S10 towards the rear counter to the forward direction of travel.

Overall, in the first variant of the embodiment of the method, it is provided that on both sides of the central axis 4 there is a synchronous and symmetrical sequence of lifting movements carried out by the massage bubbles S1, S2, S3, S4, S5, S6, S7, S8, S9, S10, S11, S12, which are symmetrically arranged on the respective sides.

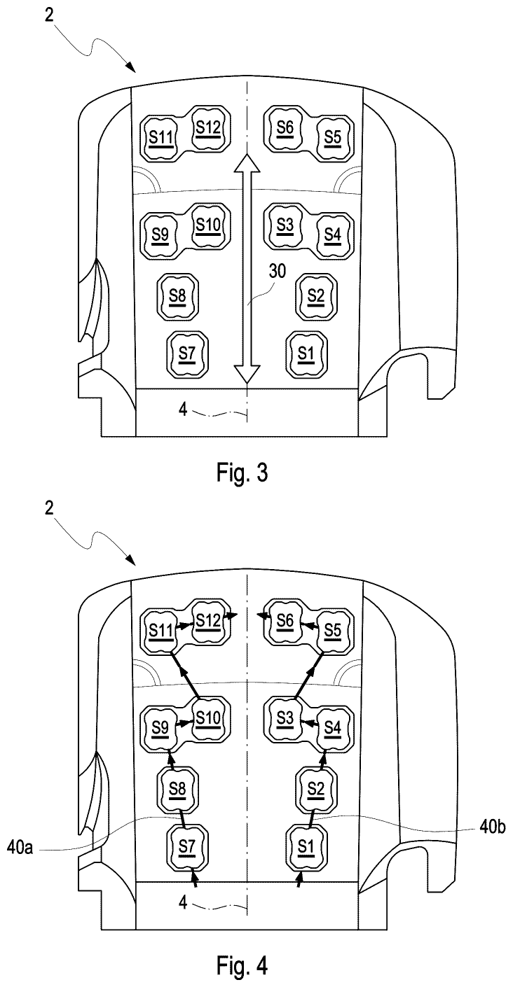

A movement pattern that is carried out using the massage system in a second variant of the embodiment of the method according to the invention is shown schematically in FIG. 3 using a double arrow 30. First the first and seventh massage bubbles S1, S7 in a first row, and then the second and eighth massage bubbles S2, S8 in a second row each carry out a lifting movement. The third, fourth, ninth, and tenth massage bubbles S3, S4, S9, S10 in a third row then each carry out another lifting movement. In addition, the massage bubbles S5, S6, S11, S12 located further forward in a fourth row can also carry out additional lifting movements. The above-mentioned massage bubbles S1, S2, S3, S4, S5, S6, S7, S8, S9, S10, S11, S12 carry out respective lifting movements in rows or row by row and therefore generate a wave-shaped movement pattern overall, i.e., from back to front.

Another movement pattern for carrying out a third variant of the embodiment of the method according to the invention is schematically illustrated in FIG. 4 by two zigzag-shaped courses 40a, 40b made up of arrows. First, lifting movements of the first and seventh massage bubbles S1, S7, then lifting movements of the second and eighth massage bubbles S2, S8, and then simultaneous lifting movements of the fourth and ninth massage bubbles S4, S9 are carried out simultaneously and symmetrically to one another, wherein sequences of these lifting movements of the massage bubbles S1, S2, S4 on the right and the massage bubbles S7, S8, S9 on the left are oriented forward along the intended forward direction of travel of the vehicle and are symmetrical to one another. Lifting movements are then carried out by the third and tenth massage bubbles S3, S10, which extend or are oriented inwards with respect to the intended sequence starting from the fourth and ninth massage bubbles S4, S9. The fifth and eleventh massage bubbles S5, S11 are then activated at the same time, wherein the sequence of lifting movements extends symmetrically to one another to the front, starting from the third and tenth massage bubbles S3, S10. Finally, lifting movements are carried out by the sixth and twelfth massage bubbles S6, S12, which, starting from the fifth and eleventh massage bubbles S5, S11, extend or are oriented symmetrically to one another and further forward and also in the direction of the central axis 4.

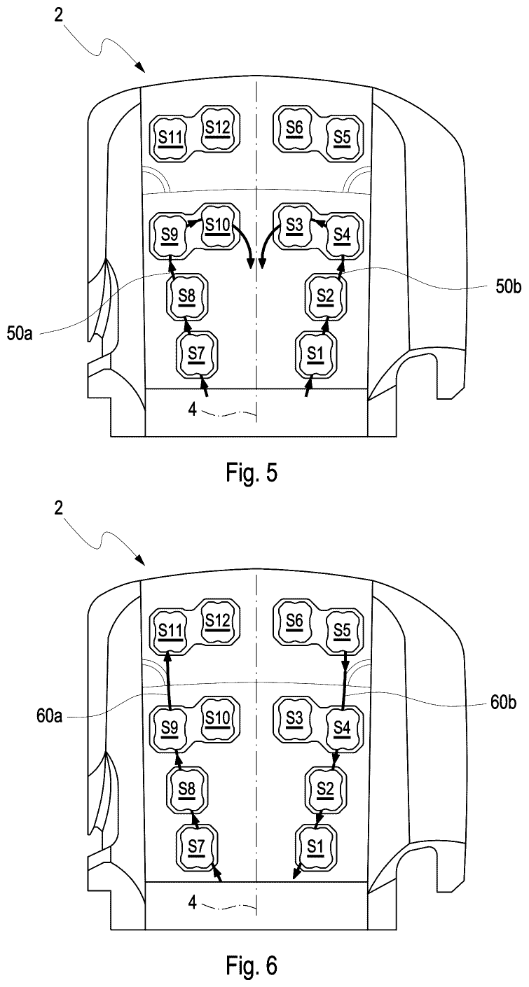

Another movement pattern for carrying out a fourth variant of the embodiment of the method according to the invention is schematically illustrated in FIG. 5 by two curved courses 50a, 50b made up of arrows. First, lifting movements of the first and seventh massage bubbles S1, S7, then lifting movements of the second and eighth massage bubbles S2, S8, and then simultaneous lifting movements of the fourth and ninth massage bubbles S4, S9 are carried out simultaneously and symmetrically to one another, wherein sequences of these lifting movements of the massage bubbles S1, S2, S4 on the right and the massage bubbles S7, S8, S9 on the left are oriented forward along the intended forward direction of travel of the vehicle and are symmetrical to one another. Lifting movements are then carried out by the third and tenth massage bubbles S3, S10, which extend or are oriented inwards and also to the rear with respect to the forward direction of travel with respect to the intended sequence starting from the fourth and ninth massage bubbles S4, S9. The movement pattern for the fourth variant of the embodiment of the method comprises a first part of the movement pattern of the third variant of the embodiment of the method from FIG. 4. To carry out a fifth variant of the embodiment of the method according to the invention using the massage system, a further movement pattern is shown schematically in FIG. 6 on the basis of a first curved course 60a made up of arrows and a second curved course 60b made up of arrows, which schematically indicate how the massage bubbles S1, S2, S4, S5 on the right and the massage bubbles S7, S8, S9, S11 on the left are activated in a temporally coordinated manner in succession and thereby carry out the lifting movements intended to provide the movement pattern intended here. Taking into consideration the two courses 60a, 60b made up of arrows, the fifth massage bubble S5 on the right and the seventh massage bubble S7 on the left are activated at the same time. The fourth massage bubble S4 on the right and the eighth massage bubble S8 on the left are then likewise activated at the same time. The second massage bubble S2 on the right and the ninth massage bubble S9 on the left are then activated at the same time. The first massage bubble S1 on the right and the eleventh massage bubble S11 on the left are then activated at the same time. A lifting movement is carried out by a respective mentioned massage bubble S1, S2, S4, S5, S7, S8, S9, S11 when it is activated according to the time sequence. The intended sequences of the massage movements on the left and right are oriented in opposite directions to one another relative to the forward movement.

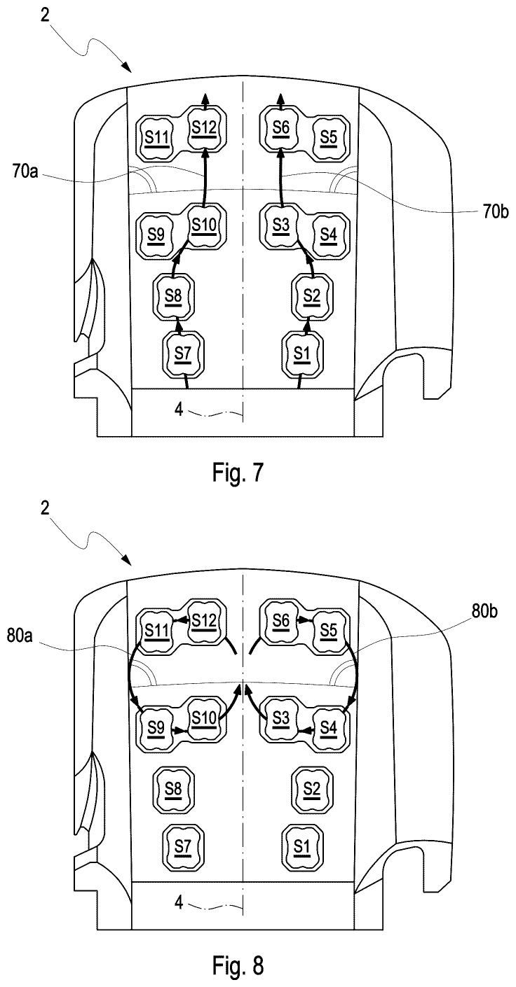

A movement pattern for carrying out a sixth variant of the embodiment of the method according to the invention is schematically illustrated in FIG. 7 by two courses 70a, 70b made up of arrows, wherein the two courses 70a, 70b made up of arrows and respected provided sequences of lifting movements are oriented symmetrically to one another and with respect to the central axis 4 and each have a first section in the form of a half wave, depending on the definition, which merges into a second substantially straight section. First, lifting movements of the first and seventh massage bubbles S1, S7, then lifting movements of the second and eighth massage bubbles S2, S8, and then simultaneous lifting movements of the third and tenth massage bubbles S3, S10 are carried out simultaneously and symmetrically to one another, wherein sequences of these lifting movements of the massage bubbles S1, S2, S3 on the right and the massage bubbles S7, S8, S10 on the left are oriented forward along the intended forward direction of travel of the vehicle and are curved in a half wave according to the first sections of the courses 70a, 70b made up of arrows. Thereafter, lifting movements are carried out by the sixth and twelfth massage bubbles S6, S12, which extend or are oriented largely straight forward with respect to the intended sequence or the second sections of the courses 70a, 70b made up of arrows starting from the third and tenth massage bubbles S3, S10. The processes according to the curves 70a, 70b from arrows are symmetrically synchronized here.

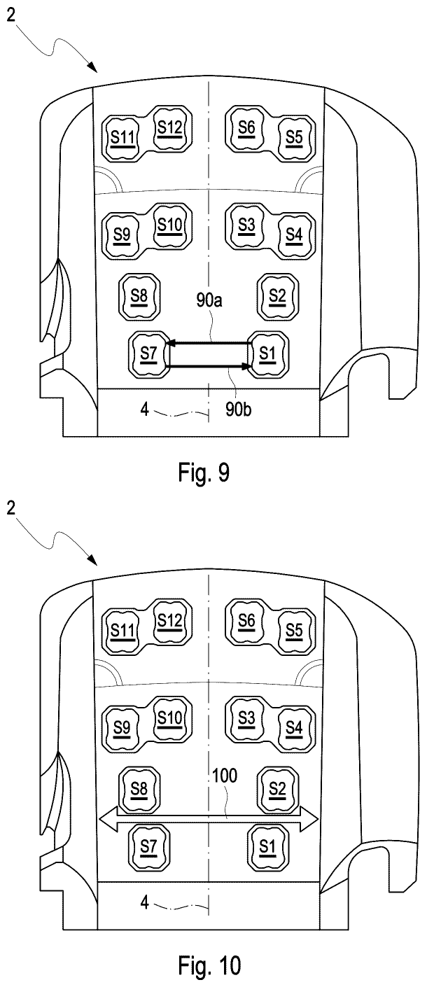

A further movement pattern for carrying out a seventh variant of the embodiment of the method according to the invention is indicated in FIG. 8 by circular courses 80a, 80b made up of arrows here. First, the sixth and twelfth massage bubbles S6, S12, then the fifth and eleventh massage bubbles S5, S11, then the fourth and ninth massage bubbles S4, S9b and finally the third and tenth massage bubbles S3, S10 are activated at the same time, the mentioned massage bubbles S6, S5, S4, S3 on the right and the massage bubbles S12, S11, S10, S9 on the left successively carry out a sequence of lifting movements, each of which is largely circular. A sequence of lifting movements of the massage bubbles S6, S5, S4, S3 is oriented clockwise on the right. Furthermore, a sequence of the lifting movements of the massage bubbles S12, S11, S10, S9 is oriented counterclockwise on the left. Alternatively thereto, it is conceivable that a sequence of the lifting movements of the massage bubbles S6, S5, S4, S3 on the right is oriented counterclockwise and a sequence of the lifting movements of the massage bubbles S12, S11, S10, S9 on the left is oriented clockwise. In an eighth variant of the embodiment of the method according to the invention, a movement pattern is carried out, which is shown schematically in FIG. 9 using the arrows 90a, 90b. In the movement pattern provided here, at least the first and seventh massage bubbles S1, S7 carry out lifting movements, for example, wherein the lifting movements of the two mentioned massage bubbles S1, S7, which are arranged symmetrically on the two different sides of the seat surface 2 beyond the central axis 4, move back and forth alternately over the central axis 4 according to a spatial and/or temporal sequence provided here. A generalization of the movement pattern is also conceivable for the eighth variant of the embodiment of the method according to the invention, wherein in each case two massage bubbles S1, S2, S3, S4, S5, S6 on the right side and S7, S8, S9, S10, S11, S12 on the left side arranged symmetrically with respect to the central axis 4 alternately carry out lifting movements in succession, wherein sequences of lifting movements extend over both sides of the seat surface 2. The lifting movements can take place symmetrically to the central axis 4 from back to front or from front to back.

A movement pattern for carrying out a ninth variant of the embodiment of the method according to the invention is shown schematically in FIG. 10 using a double arrow 100. First, synchronous lifting movements are carried out by the first and second massage bubbles S1, S2. The seventh and eighth massage bubbles S7, S8 then carry out synchronous lifting movements. In addition, it is possible here for synchronous lifting movements by the third and fourth massage bubbles S3, S4 and then synchronous lifting movements by the ninth and tenth massage bubbles S9 and S10 to be carried out. It is also possible that first the fourth and fifth massage bubbles S4, S5, synchronously thereto the third and sixth massage bubbles S3, S6, and then the tenth and twelfth massage bubbles S10, S12 and synchronously thereto the ninth and eleventh massage bubbles S9, S11 carry out lifting movements, wherein alternatively, a reverse sequence is also possible. A wave-shaped movement pattern can be generated from left to right or from right to left.

In this ninth variant, it is possible for the two sequences of lifting movements on the right and left of the central axis 4 to be oriented forward and at the same time from the inside to the outside, starting from the central axis 4, wherein the sequences extend over both sides of the seat surface 2 depending on the definition.

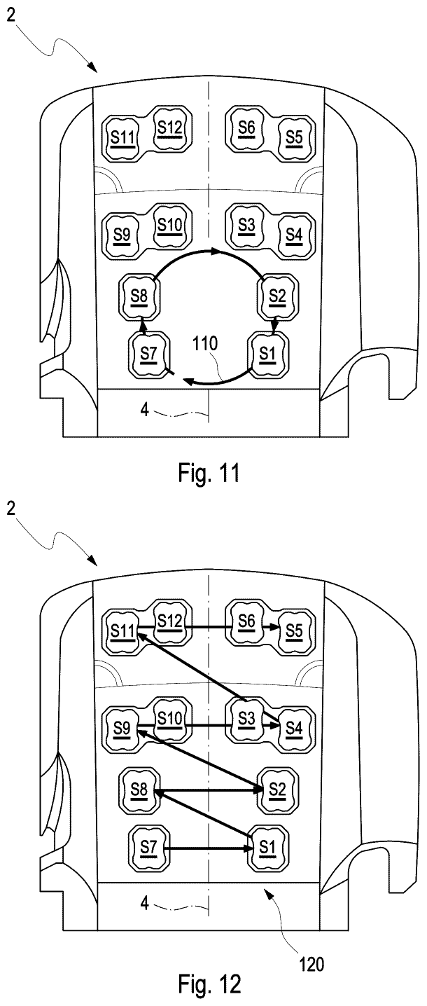

A movement pattern that is carried out to carry out a tenth variant of the embodiment of the method according to the invention is shown schematically in FIG. 11 using a circular course 110 made up of arrows. According to this movement pattern, first the seventh massage bubble S7 and then the eighth massage bubble S8, both of which are arranged on the left side, carry out lifting movements in succession. A lifting movement is then carried out on the right side, first by the second massage bubble S2 and finally by the first massage bubble S1, wherein the sequence of all lifting movements of the mentioned massage bubbles S1, S2, S7, S8 is circular here in a clockwise direction. It is possible for the sequence of lifting movements to continue, wherein the seventh massage bubble S7 on the left carries out a new lifting movement after the first massage bubble S1 on the right. Alternatively, it is also possible that the sequence of lifting movements can also be oriented counterclockwise, taking into consideration the circular course 110 of arrows. A respective circular sequence of lifting movements extends here over both sides of the seat surface 2.

To carry out an eleventh variant of the embodiment of the method according to the invention, reference is made to a massage pattern, which is indicated in FIG. 12 using a group of arrows 120 made up of multiple arrows arranged one behind another in a zigzag shape. According to this movement pattern, a lifting movement is first carried out by the seventh massage bubble S7 on the left and then by the first massage bubble S1 on the right, then a lifting movement is carried out by the eighth massage bubble S8 on the left. A further lifting movement is then carried out by the second massage bubble S2 on the right. A lifting movement is then carried out by the ninth massage bubble S9 on the left. A lifting movement is then carried out by the tenth massage bubble S10 on the left. A lifting movement is then carried out by the third massage bubble S3 on the right. A lifting movement is then carried out by the fourth massage bubble S4 on the right. A lifting movement is then carried out by the eleventh massage bubble S11 on the left. A lifting movement is then carried out by the twelfth massage bubble S12 on the left. A lifting movement is then carried out by the sixth massage bubble S6 on the right. Finally, a lifting movement is then carried out by the fifth massage bubble S5 on the right. Thus, a sequence of the intended lifting movements runs alternately from the left to the right side and from the right to the left side, wherein the central axis 4 is crossed several times. A mirrored and/or reversed sequence of lifting movements to provide a mirrored and/or reversed massage pattern is also alternatively conceivable here. It is therefore also possible for lifting movements to run forwards and/or backwards.

In a further embodiment of the method, it is possible for multiple of the above-described variants of the embodiment of the method and thus respective movement patterns and/or sequences of lifting movements of the massage bubbles S1, S2, S3, S4, S5, S6, S7, S8, S9, S10, S11, S12 are carried out combined in time and space, for example in succession and/or superimposed. The intended and/or predetermined movement patterns are stored in a memory of the at least one control device and/or in a database and are retrievable therefrom, so that the massage bubbles S1, S2, S3, S4, S5, S6, S7, S8, S9, S10, S11, S12 can be actuated accordingly by the at least one control device.

1-9. (canceled)

10. A massage system for a seat of a vehicle, comprising: a seat surface, wherein multiple massage bubbles are arranged in the seat surface of the seat, wherein each massage bubble is designed to carry out at least one lifting movement having a component extending perpendicular to the seat surface, to touch a body of a person seated on the seat surface in an area, and to carry out a massage for this area, wherein at least two massage bubbles are designed to carry out their respective lifting movements in a time-coordinated manner and in accordance with at least one intended movement pattern.

11. The massage system according to claim 10, in which the massage bubbles are arranged symmetrically relative to a central axis of the seat surface, which is oriented parallel to a forward direction of travel of the vehicle.

12. The massage system according to claim 10, in which at least one massage bubble is designed as a pneumatic massage bubble.

13. The massage system according to claim 10, which has at least one control device which is connected to at least one massage bubble and is designed to supervise the lifting movement of the at least one massage bubble.

14. A method for massaging at least one area of a body of a person sitting on a seat surface of a seat of a vehicle, using a massage system for the seat of the vehicle, wherein multiple massage bubbles of the massage system are arranged in the seat surface of the seat, wherein each massage bubble carries out at least one lifting movement having a component extending perpendicular to the seat surface, wherein the body of the person is touched by the respective massage bubble in the at least one area, wherein at least two massage bubbles carry out their respective lifting movements temporally coordinated to one another and according to at least one intended movement pattern.

15. The method according to claim 14, in which a thigh, an ischial tuberosity, and/or a buttock of the person is massaged as the at least one area.

16. The method according to claim 14, in which, to provide the intended movement pattern, at least one lifting movement is carried out by at least one first massage bubble and immediately thereafter a second lifting movement is carried out by at least one second massage bubble, wherein the at least one first massage bubble is arranged in front of or behind the at least one second massage bubble with respect to a forward direction of travel of the vehicle, and/or wherein the at least one first massage bubble and the at least one second massage bubble, with respect to a central axis of the seat surface, which is oriented parallel to a forward direction of travel of the vehicle, are separated from one another by the central axis or are arranged on the same side of the seat surface with respect to the central axis.

17. The method according to claim 16, in which a first sequence of lifting movements is carried out in succession by a first set of massage bubbles and a second sequence of lifting movements is carried out in succession by a second set of massage bubbles, wherein the massage bubbles of the first set and the massage bubbles of the second set are arranged symmetrically with respect to the central axis of the seat surface and/or wherein the two sequences of lifting movements are carried out synchronously with one another.

18. The method according to claim 14, in which gas is filled into massage bubbles, which are designed as pneumatic massage bubbles, wherein, at one time, the same amount of air is stored in at least two pneumatic massage bubbles, and/or wherein different amounts of air are stored in at least two pneumatic massage bubbles.

19. The massage system according to claim 11, in which at least one massage bubble is designed as a pneumatic massage bubble.

20. The massage system according to claim 11, which has at least one control device which is connected to at least one massage bubble and is designed to supervise the lifting movement of the at least one massage bubble.

21. The massage system according to claim 12, which has at least one control device which is connected to at least one massage bubble and is designed to supervise the lifting movement of the at least one massage bubble.

22. The method according to claim 15, in which, to provide the intended movement pattern, at least one lifting movement is carried out by at least one first massage bubble and immediately thereafter a second lifting movement is carried out by at least one second massage bubble, wherein the at least one first massage bubble is arranged in front of or behind the at least one second massage bubble with respect to a forward direction of travel of the vehicle, and/or wherein the at least one first massage bubble and the at least one second massage bubble, with respect to a central axis of the seat surface, which is oriented parallel to a forward direction of travel of the vehicle, are separated from one another by the central axis or are arranged on the same side of the seat surface with respect to the central axis.

23. The method according to claim 15, in which gas is filled into massage, which are designed as pneumatic massage bubbles, wherein, at one time, the same amount of air is stored in at least two pneumatic massage bubbles, and/or wherein different amounts of air are stored in at least two pneumatic massage bubbles.

24. The method according to claim 16, in which gas is filled into massage bubbles, which are designed as pneumatic massage bubbles, wherein, at one time, the same amount of air is stored in at least two pneumatic massage bubbles, and/or wherein different amounts of air are stored in at least two pneumatic massage bubbles.

25. The method according to claim 17, in which gas is filled into massage bubbles, which are designed as pneumatic massage bubbles, wherein, at one time, the same amount of air is stored in at least two pneumatic massage bubbles, and/or wherein different amounts of air are stored in at least two pneumatic massage bubbles.
